(19) United States
(12) Patent Application Publication
(10) Pub. No.: US 2024/0332507 A1
(43) Pub. Date: Oct. 3, 2024

(54) PRE-LITHIATION WITH FLUORIDES AND DUAL LAYER COATINGS

(71) Applicant: Apple Inc., Cupertino, CA (US)

(72) Inventors: Vinay Bhat, Pleasanton, CA (US); Christopher T. Campbell, San Jose, CA (US)

(21) Appl. No.: 18/593,508

(22) Filed: Mar. 1, 2024

Related U.S. Application Data
(60) Provisional application No. 63/492,428, filed on Mar. 27, 2023.

(51) Int. Cl. H01M 4/36; H01M 4/02; H01M 4/04; H01M 4/485; H01M 4/58; H01M 4/62; H01M 10/0525

(52) U.S. Cl. CPC H01M 4/366; H01M 4/0404; H01M 4/485; H01M 4/58; H01M 4/623; H01M 4/625; H01M 10/0525; H01M 2004/028

(57) ABSTRACT

This disclosure relates to battery cells, and more particularly, methods and compositions for pre-lithiation of battery cells.

### PRIORITY

This patent application claims priority to U.S. Provisional Patent Application No. 63/492,428 filed on Mar. 27, 2023, which is incorporated herein by reference in its entirety.

### FIELD

This disclosure relates generally to battery cells, and more particularly, pre-lithiation of lithium ion (Li-ion) battery cells.

### BACKGROUND

Li-ion battery cells are widely used as the power sources in consumer electronics. Consumer electronics need Li-ion battery cells which can deliver higher volumetric energy densities and sustain more discharge-charge cycles.

Frequently in conventional Li-ion battery cells, adding lithium results in a loss of lithium ions. The loss of lithium ions results in diminished performance of battery cells. There is a need to replace lithium in Li-ion battery cells to compensate for Li loss.

### SUMMARY

In a first aspect, the disclosure is directed to a cathode. The cathode includes a current collector, a cathode active material layer disposed on the cathode current collector, and a pre-lithiation layer disposed on the cathode active material layer. The pre-lithiation layer comprising a lithium-containing fluoride or oxyfluoride, a metal fluoride and/or metal oxyfluoride, a first binder, and a conductive material.

In a second aspect, the disclosure is directed to a battery cell. The battery cells include the cathode, an anode, and a separator disposed between the cathode and anode. The cathode includes a cathode active material layer disposed on the cathode current collector, and a pre-lithiation layer disposed on the cathode active material layer. The pre-lithiation layer comprising a lithium-containing fluoride or oxyfluoride, a metal fluoride and/or metal oxyfluoride, a first binder, and a conductive material. The anode includes an anode active material disposed on an anode current collector. The anode oriented towards the cathode such that the anode active material faces the pre-lithiation layer. The pre-lithiation layer of the cathode is oriented toward the anode.

In a third aspect, the disclosure is directed to a set of layers including a separator and a pre-lithiation layer disposed on the separator. The pre-lithiation layer includes a lithium-containing fluoride or oxyfluoride, a metal fluoride and/or metal oxyfluoride, a binder, and a conductive material.

In a fourth aspect, the disclosure is directed to a battery cell including a cathode, an anode, and a set of layers disposed therebetween. The cathode includes a cathode current collector and a cathode active material layer disposed on the cathode current collector. The anode includes an anode active material disposed on an anode current collector. The anode is oriented towards the cathode such that the anode active material faces the cathode active material. The set of layers includes a separator and a the pre-lithiation layer disposed on the separator. The pre-lithiation layer faces the cathode.

In a fifth aspect, the cathode includes a current collector and a cathode active material layer disposed on the cathode current collector. The cathode active material layer includes a cathode active material, a lithium-containing fluoride or oxyfluoride, a metal fluoride and/or metal oxyfluoride, a binder, and a conductive material.

In a sixth aspect, the disclosure is directed to a cathode including a cathode current collector and a cathode active material layer disposed on the cathode current collector. The cathode active material layer includes a plurality of cathode active material particles, a binder, and a conductive material. The plurality of cathode active material particles includes a cathode active material, a lithium-containing fluoride or oxyfluoride, and a metal fluoride and/or metal oxyfluoride.

In a seventh aspect, the battery cell includes the cathode, an anode comprising an anode active material disposed on an anode current collector, the anode oriented towards the cathode such that the anode active material faces the cathode active material. A separator is disposed between the cathode and the anode.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment; and

FIG. 2 is a side view of a battery cell, in accordance with an illustrative embodiment;

FIG. 3A depicts a side view of a cathode, in accordance with an illustrative embodiment;

FIG. 3B depicts a side view of battery cell, in accordance with an illustrative embodiment;

FIG. 4A depicts a side view of a set of layers including pre-lithiation layer disposed on a separator, in accordance with an illustrative embodiment; and

FIG. 4B depicts a side view of a battery cell, in accordance with an illustrative embodiment.

### DETAILED DESCRIPTION

Reference will now be made in detail to representative embodiments illustrated in the accompanying drawings. The following descriptions are not intended to limit the embodiments to one preferred embodiment. To the contrary, it is intended to cover alternatives, modifications, and equivalents as can be included within the spirit and scope of the described embodiments as defined by the appended claims.

Li-ion battery cells store energy by moving lithium ions from the cathode to the anode during the charging process. This stored energy can be utilized by moving lithium from the anode to the cathode during discharging process. The total amount of lithium in the cell can be one of the factors that determine the energy density of the Li-ion battery cell.

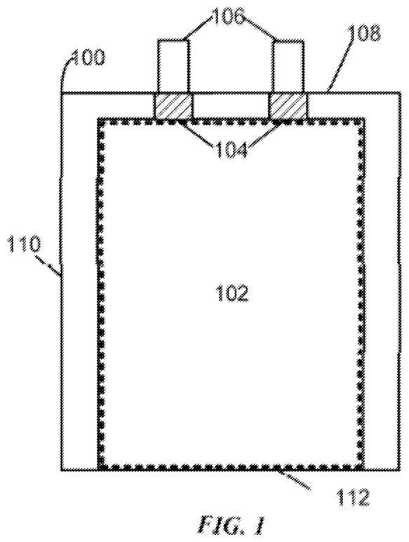

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing layers that include a cathode with a cathode active coating, a separator, and an anode with an anode active coating. More specifically, the stack 102 may include one strip of cathode (e.g., aluminum foil coated with a lithium compound) and one strip of anode (e.g., copper foil coated with graphite). The stack 102 also includes one strip of separator material (e.g., a microporous polymer membrane or non-woven fabric mat) disposed between the cathode and anode. The cathode, anode, and separator may be left flat in a planar configuration or may be wrapped into a wound configuration (e.g., a “jelly roll”). An electrolyte solution is disposed between each cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

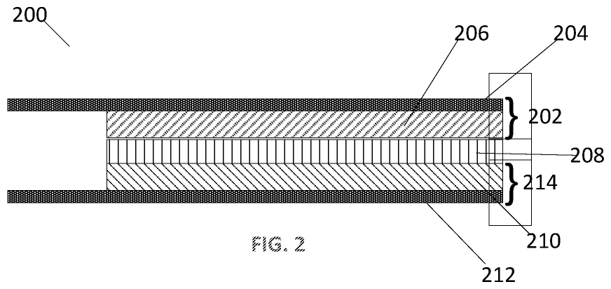

FIG. 2 presents a perspective view of a battery cell 200 (e.g., the battery cell 100 of FIG. 1) in accordance with the disclosed embodiments. The battery cell 200 includes a cathode 202. The cathode 202 includes a cathode current collector 204 and cathode active material layer 206. The battery cell 200 also includes an anode 214. The anode 214 include the anode current collector 212 and anode active material 210. A separator 208 is disposed between the cathode 202 and anode 214. During battery operation, an electrolyte fluid is disposed between cathode 202 and anode 214. The electrolyte fluid is in contact with separator 208.

To create the battery cell, cathode 202, separator 208, and anode 214 may be stacked in a planar configuration, or alternatively stacked and then wrapped into a wound configuration. The electrolyte fluid 216 can then be added.

After assembly, Li-ion battery cells undergo an initial formation process to condition the cells for operation. In conventional methods, a significant portion of lithium is lost due to the side reactions during this process. The loss of lithium in turn reduces the energy density of the cell, resulting in less effective battery operation. This loss of lithium can be compensated with additional lithium to improve energy density of the Li-ion battery cells.

Conventional methods of anode pre-lithiation can lead to formation of an unstable passivation film on the anode during formation process. The unstable passivation films can negatively affect Li-ion battery performance and reduce the life span of the Li-ion battery cells.

### Reaction-Based Lithiation

The disclosure provides reaction-based conversion systems to provide lithium to the cell. In various embodiments, a pre-lithiation layer including a lithium-containing fluoride or oxyfluoride, metal fluoride or metal oxyfluoride, a binder, and a conductive material is disposed on the surface of the cathode active material layer or the cathode side of the separator. Alternatively, the cathode active material layer is modified to include a lithium-containing fluoride or oxyfluoride, metal fluoride or metal oxyfluoride, and a conductive material. The reaction-based conversion of a lithium-containing fluoride or oxyfluoride to lithium ions and fluoride ions thereby results in pre-lithiation of the battery cell.

The systems and methods can be achieved in different variations.

### A. Pre-lithiation Layer Disposed on the Cathode Active Material Layer

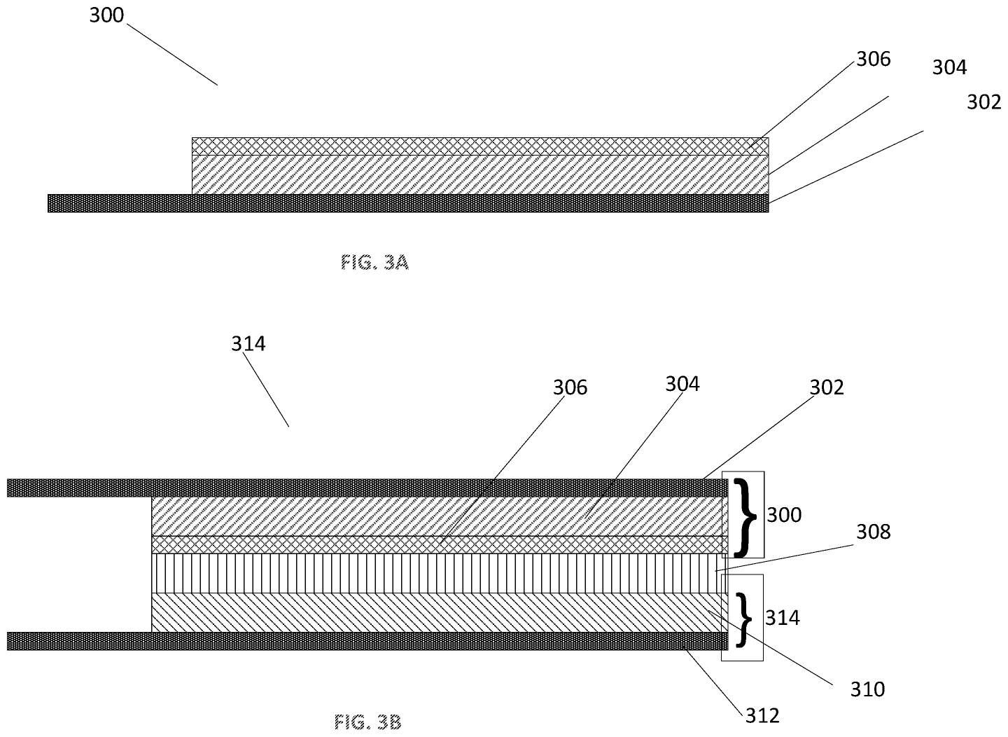

In one variation, a pre-lithiation layer is disposed on the surface of the cathode active material layer. FIG. 3A depicts a side view of cathode 300 includes a cathode current collector 302, a cathode active material layer 304 disposed on the cathode current collector 302, and a pre-lithiation layer 306 disposed on the cathode active material layer 304. FIG. 3B depicts a side view of battery cell 314, including cathode 300, separator 308, and anode 314. The cathode 300 includes a cathode current collector 302, a cathode active material layer 304 disposed on the cathode current collector 302, and a pre-lithiation layer 306 disposed on the cathode active material layer 304. Anode 314 includes anode active material layer 310 and anode current collector 312.

The pre-lithiation layer 306 includes a lithium-containing fluoride or oxyfluoride, a metal fluoride and/or metal oxyfluoride, a binder, and a conductive material. The a lithium-containing fluoride or oxyfluoride reacts with the metal fluorides and/or metal oxyfluorides to release Li ions in the system. Lithium ions released from the reaction lithiate the battery cell.

The cathode current collector 302 and anode current collector 312 may be any material known in the art. In some variations, the cathode current collector 302 may be an aluminum foil. In some variations, the anode current collector 312 may be a copper foil.

The anode active material can be any anode active material known in the art. In various non-limiting examples, the anode active material can be carbon-based, such as graphite. In additional non-limiting examples, the anode active material can include silicon, silicon oxide, lithium metal, and various alloys. In additional variations, the anode active material can include one or more of graphite, hard carbon, silicon, silicon oxide, silicon-carbon, and composite materials.

### 1. Pre-Lithiation Layer

The pre-lithiation layer 306 includes a lithium-containing fluoride or oxyfluoride, metal fluoride and/or metal oxyfluoride, a binder, and a conductive material. Any metal fluoride and/or metal oxyfluoride known in the art can be used. Non-limiting examples of the metal fluorides include FcF₃, CuF₂, CoF₂. Non-limiting examples of metal oxyfluorides include FeFO and CuFO. In some variations, the metal fluoride/metal oxyfluoride is FeF₃. In some variations, the metal fluoride/metal oxyfluoride is CuF₂. In some variations, the metal fluoride/metal oxyfluoride is CoF₂. In some variations, the metal fluoride/metal oxyfluoride is FeFO. In some variations, the metal fluoride/metal oxyfluoride is CuFO. The metal fluorides and metal oxyfluorides can be in the form of a particle or a nano-sized iron particle.

In variations, the lithium-containing fluoride or oxyfluoride can be any lithium-containing fluoride or oxyfluoride known in the art. In more specific variations, lithium-containing fluoride or oxyfluoride can be selected from LiF, LiFcF₃, LiMnFO, Li₂NiO₂F, or a lithium poly/pyrophosphate (e.g., Li₂FeP₂O₇ or LiFe₂P₃O₁₀). In some variations, the lithium-containing fluoride or oxyfluoride is LiF.

The selection of the metal fluoride or metal oxyfluoride can be selected based on the battery.

Specific metal fluoride or metal oxyfluoride include. FcF₃FcF₂, NiF₂, and CuF₂. Other metal fluoride or metal oxyfluorides can include Co, Mn, Al, Na, K, Mg, Ca, Cr, Ti, V, and Si. In certain variations, the amount of Li adds between 1 wt % and 40 wt % of Li capacity of the battery.

In some variations, up to 20 wt % extra Li in the form of a lithium-containing fluoride or oxyfluoride is added to the system. In some variations, at least 0.5 wt % Li of the stoichiometric amount of Li is added in the form of a lithium-containing fluoride or oxyfluoride to the pre-lithiation layer. In some variations, at least 1 wt % Li of the stoichiometric amount of Li is added in the form of a lithium-containing fluoride or oxyfluoride to the pre-lithiation layer. In some variations, at least 2 wt % Li of the stoichiometric amount of Li is added in the form of a lithium-containing fluoride or oxyfluoride to the pre-lithiation layer. In some variations, at least 3 wt % Li of the stoichiometric amount of Li is added in the form of a lithium-containing fluoride or oxyfluoride to the pre-lithiation layer. In some variations, at least 4 wt % Li of the stoichiometric amount of Li is added in the form of a lithium-containing fluoride or oxyfluoride to the pre-lithiation layer. In some variations, at least 5 wt % Li of the stoichiometric amount of Li is added in the form of a lithium-containing fluoride or oxyfluoride to the pre-lithiation layer. In some variations, at least 6 wt % Li of the stoichiometric amount of Li is added in the form of a lithium-containing fluoride or oxyfluoride to the pre-lithiation layer. In some variations, at least 7 wt % Li of the stoichiometric amount of Li is added in the form of a lithium-containing fluoride or oxyfluoride to the pre-lithiation layer. In some variations, at least 8 wt % Li of the stoichiometric amount of Li is added in the form of a lithium-containing fluoride or oxyfluoride to the pre-lithiation layer. In some variations, at least 9 wt % Li of the stoichiometric amount of Li is added in the form of a lithium-containing fluoride or oxyfluoride to the pre-lithiation layer. In some variations, at least 10 wt % Li of the stoichiometric amount of Li is added in the form of a lithium-containing fluoride or oxyfluoride to the pre-lithiation layer. In some variations, at least 11 wt % Li of the stoichiometric amount of Li is added in the form of a lithium-containing fluoride or oxyfluoride to the pre-lithiation layer. In some variations, at least 12 wt % Li of the stoichiometric amount of Li is added in the form of a lithium-containing fluoride or oxyfluoride to the pre-lithiation layer. In some variations, at least 13 wt % Li of the stoichiometric amount of Li is added in the form of a lithium-containing fluoride or oxyfluoride to the pre-lithiation layer. In some variations, at least 14 wt % Li of the stoichiometric amount of Li is added in the form of a lithium-containing fluoride or oxyfluoride to the pre-lithiation layer. In some variations, at least 15 wt % Li of the stoichiometric amount of Li is added in the form of a lithium-containing fluoride or oxyfluoride to the pre-lithiation layer. In some variations, at least 16 wt % Li of the stoichiometric amount of Li is added in the form of a lithium-containing fluoride or oxyfluoride to the pre-lithiation layer. In some variations, at least 17 wt % Li of the stoichiometric amount of Li is added in the form of a lithium-containing fluoride or oxyfluoride to the pre-lithiation layer. In some variations, at least 18 wt % Li of the stoichiometric amount of Li is added in the form of a lithium-containing fluoride or oxyfluoride to the pre-lithiation layer. In some variations, at least 19 wt % Li of the stoichiometric amount of Li is added in the form of a lithium-containing fluoride or oxyfluoride to the pre-lithiation layer.

In some variations, less than or equal to 20 wt % Li of the stoichiometric amount of Li is added in the form of a lithium-containing fluoride or oxyfluoride to the pre-lithiation layer. In some variations, less than or equal to 19 wt % Li of the stoichiometric amount of Li is added in the form of a lithium-containing fluoride or oxyfluoride to the pre-lithiation layer. In some variations, less than or equal to 18 wt % Li of the stoichiometric amount of Li is added in the form of a lithium-containing fluoride or oxyfluoride to the pre-lithiation layer. In some variations, less than or equal to 17 wt % Li of the stoichiometric amount of Li is added in the form of a lithium-containing fluoride or oxyfluoride to the pre-lithiation layer. In some variations, less than or equal to 16 wt % Li of the stoichiometric amount of Li is added in the form of a lithium-containing fluoride or oxyfluoride to the pre-lithiation layer. In some variations, less than or equal to 15 wt % Li of the stoichiometric amount of Li is added in the form of a lithium-containing fluoride or oxyfluoride to the pre-lithiation layer. In some variations, less than or equal to 14 wt % Li of the stoichiometric amount of Li is added in the form of a lithium-containing fluoride or oxyfluoride to the pre-lithiation layer. In some variations, less than or equal to 13 wt % Li of the stoichiometric amount of Li is added in the form of a lithium-containing fluoride or oxyfluoride to the pre-lithiation layer. In some variations, less than or equal to 12 wt % Li of the stoichiometric amount of Li is added in the form of a lithium-containing fluoride or oxyfluoride to the pre-lithiation layer. In some variations, less than or equal to 11 wt % Li of the stoichiometric amount of Li is added in the form of a lithium-containing fluoride or oxyfluoride to the pre-lithiation layer. In some variations, less than or equal to 10 wt % Li of the stoichiometric amount of Li is added in the form of a lithium-containing fluoride or oxyfluoride to the pre-lithiation layer. In some variations, less than or equal to 9 wt % Li of the stoichiometric amount of Li is added in the form of a lithium-containing fluoride or oxyfluoride to the pre-lithiation layer. In some variations, less than or equal to 8 wt % Li of the stoichiometric amount of Li is added in the form of a lithium-containing fluoride or oxyfluoride to the pre-lithiation layer. In some variations, less than or equal to 7 wt % Li of the stoichiometric amount of Li is added in the form of a lithium-containing fluoride or oxyfluoride to the pre-lithiation layer. In some variations, less than or equal to 6 wt % Li of the stoichiometric amount of Li is added in the form of a lithium-containing fluoride or oxyfluoride to the pre-lithiation layer. In some variations, less than or equal to 5 wt % Li of the stoichiometric amount of Li is added in the form of a lithium-containing fluoride or oxyfluoride to the pre-lithiation layer. In some variations, less than or equal to 4 wt % Li of the stoichiometric amount of Li is added in the form of a lithium-containing fluoride or oxyfluoride to the pre-lithiation layer. In some variations, less than or equal to 3 wt % Li of the stoichiometric amount of Li is added in the form of a lithium-containing fluoride or oxyfluoride to the pre-lithiation layer. In some variations, less than or equal to 2 wt % Li of the stoichiometric amount of Li is added in the form of a lithium-containing fluoride or oxyfluoride to the pre-lithiation layer.

In various aspects, the lower and upper boundary of the range of the lithium-containing fluoride or oxyfluoride can be any combination described herein. In various aspects, the range of extra Li can be added based on expected losses in the system that are expected.

The binder can be any binder known in the art. Non-limiting variations of different binders include PVDF, PVDF-HFP, PAN, SBR, NBR, PIB, PP, PAA, CMC, and others known in the art. In some variations, the binder is polyvinylidene difluoride (PVdF). In the pre-lithiation layer, the binder can be from 1 wt % to 20 wt % w/w.

In various aspects, the pre-lithiation layer 306 can have an average thickness of 50 nm to 200 microns. The pre-lithiation layer thickness can be described as having a lower boundary, an upper boundary, or both in any combination as described herein.

In some variations, the average thickness of the pre-lithiation layer is at least 25 nm. In some variations, the average thickness of the pre-lithiation layer is at least 50 nm. In some variations, the average thickness of the pre-lithiation layer is at least 100 nm. In some variations, the average thickness of the pre-lithiation layer is at least 250 nm. In some variations, the average thickness of the pre-lithiation layer is at least 500 nm. In some variations, the average thickness of the pre-lithiation layer is at least 750 nm. In some variations, the average thickness of the pre-lithiation layer is at least 1 micron. In some variations, the average thickness of the pre-lithiation layer is at least 5 microns. In some variations, the average thickness of the pre-lithiation layer is at least 10 microns. In some variations, the average thickness of the pre-lithiation layer is at least 25 microns. In some variations, the average thickness of the pre-lithiation layer is at least 50 microns. In some variations, the average thickness of the pre-lithiation layer is at least 75 microns. In some variations, the average thickness of the pre-lithiation layer is at least 100 microns. In some variations, the average thickness of the pre-lithiation layer is at least 125 microns. In some variations, the average thickness of the pre-lithiation layer is at least 150 microns. In some variations, the average thickness of the pre-lithiation layer is at least 175 microns.

In some variations, the average thickness of the pre-lithiation layer is less than or equal to 200 microns. In some variations, the average thickness of the pre-lithiation layer is less than or equal to 175 microns. In some variations, the average thickness of the pre-lithiation layer is less than or equal to 150 microns. In some variations, the average thickness of the pre-lithiation layer is less than or equal to 125 microns. In some variations, the average thickness of the pre-lithiation layer is less than or equal to 100 microns. In some variations, the average thickness of the pre-lithiation layer is less than or equal to 75 microns. In some variations, the average thickness of the pre-lithiation layer is less than or equal to 50 microns. In some variations, the average thickness of the pre-lithiation layer is less than or equal to 25 microns. In some variations, the average thickness of the pre-lithiation layer is less than or equal to 10 microns. In some variations, the average thickness of the pre-lithiation layer is less than or equal to 1 micron. In some variations, the average thickness of the pre-lithiation layer is less than or equal to 750 nm. In some variations, the average thickness of the pre-lithiation layer is less than or equal to 500 nm. In some variations, the average thickness of the pre-lithiation layer is less than or equal to 250 nm. In some variations, the average thickness of the pre-lithiation layer is less than or equal to 100 nm. In some variations, the average thickness of the pre-lithiation layer is less than or equal to 75 nm. In some variations, the average thickness of the pre-lithiation layer is less than or equal to 50 nm.

### 2. Conductive Material

The conductive material can be any conductive material used in a battery known in the art. In some variations, the conductive material is carbon black or graphite. In other variations, the conductive material can be in a powder form.

### 3. Cathode Active Material Layer

Returning to FIGS. 3A and 3B, the cathode active material layer 304 includes at least a cathode active material, binder, and conductive material.

The binder in the cathode active material layer 304 can be any binder or binders as described for the pre-lithiation layer 306. The binder or binders in cathode active material layer 304 can be the same or different from the binder in the pre-lithiation layer 306.

In some variations of the cathode active material layer 304, the binder is less than or equal to 10 wt % wt %. In some variations, the binder can be at least 0.5 wt % of the total cathode active material layer, and less than 10 wt % of the cathode active material layer.

In various aspects, the cathode active material can be a layered having the general formula LiₓMO₂, a spinel with the general formula LiₓM₂O₄, or an olivine with the general formula LiₓMPO₄, wherein M is one or more transition metals and 0.90≤x≤1.10.

In some variations, the cathode active material can be an oxide having the general formula LiₓMO₂. Non-limiting examples of such cathode active materials include LiCoO₂ (LCO), Li(NiₓCo_{y}Mn_{z})O₂(NCM), and LiNi_{0.95}Al_{0.05}O₂ (NCA). Such materials can be, for example, Ser. Nos. 14/206,654, 15/458,604, 15/458,612, 15/709,961, 15/710,540, 15/804,186, 16/531,883, 16/529,545, 16/999,307, 16/999,328, 16/999,265, each of which is incorporated herein by reference in its entirety.

In some variations, the cathode active material can be a spinel having the general formula LiₓM₂O₄. Non-limiting examples of such cathode active materials include LiMn₂O₄ (LMO) and LiMn_{1.5}Ni_{0.5}O₄ (LMNO).

In some variations, the cathode active material can be an olivine having the general formula LiₓMPO₄. Non-limiting examples of such cathode active materials include LiFePO₄ and LiMn_{0.8}Fe_{0.2}PO₄ (LMFP).

The structural stability of different classes of cathode active materials increases in the order of layered oxides<spinels<olivines. In some variations of olivine cathode active material, the cathode active material can be lithium iron phosphate (LFP). Li ion battery cells that contain LFP cathodes release less heat than cells containing other types of cathode materials. Cathodes can include transition metal oxides, transition metal oxyflourides, transition metal phosphides (e.g., LFP, LMO, NCM, NCA, LCO cathode active materials).

### 4. Separator

Returning to FIGS. 3A and 3B, separator 308 is a structure in battery cell 304 that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation. Separator 308 can be interposed layers between the cathode and anode. Separator 308 can include any material known in the art. For example, separator 308 may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (PVdF). Other microporous polymer membranes or non-woven fabric mats are possible (e.g., gel polymer electrolytes).

### 5. Electrolytes

An electrolyte formulation is added to the system. In general, electrolyte formulation can act a conductive pathway for the movement of cations passing from the negative to the positive electrodes during discharge. The electrolyte formulation can include an electrolyte salt, electrolyte solvent, and one or more electrolyte additives.

The electrolyte formulation can have one or more electrolyte salts dissolved therein. The salt may be any type of salt suitable for battery cells. For example, and without limitation, salts for a lithium-ion battery cell include LiPF₆, LiBF₄, LiClO₄, LiSO₃CF₃, LIN(SO₂F)₂, LIN(SO₂CF₃)₂, LiBC₄O₈, Li[PF₃(C₂CF₅)₃], LiBF₂(C₂O₄), and LiC(SO₂CF₃)₃. Other salts are possible, including combinations of salts.

The electrolyte formulation can include electrolyte solvents. The electrolyte solvent may be any type of electrolyte solvent suitable for battery cells. Electrolyte solvents can contain a mixture of organic solvents such as, but not limited to, carbonates, esters, ethers, nitriles, ionic liquids. Solvent blends can include ethylene carbonate (EC), linear carbonates such as dimethyl carbonate (DMC), diethyl carbonate (DEC) and ethyl methyl carbonate (EMC). Non-limiting examples of the electrolyte solvents include propylene carbonate (PC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), or combinations thereof.

In some variations, the electrolyte formulation can include one or more additional electrolyte additives. In various aspects, the electrolyte additives can include pro-1-ene-1,3-sultone (PES), methylene methanedisulfonate (MMDS), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl) ether (EGPN), and/or 1,3,6-hexanetricarbonitrile (HTCN), tris(trimethyl silyl) phosphite (TMSP), in any combination.

### B. Pre-lithiation Layer Disposed on the Separator

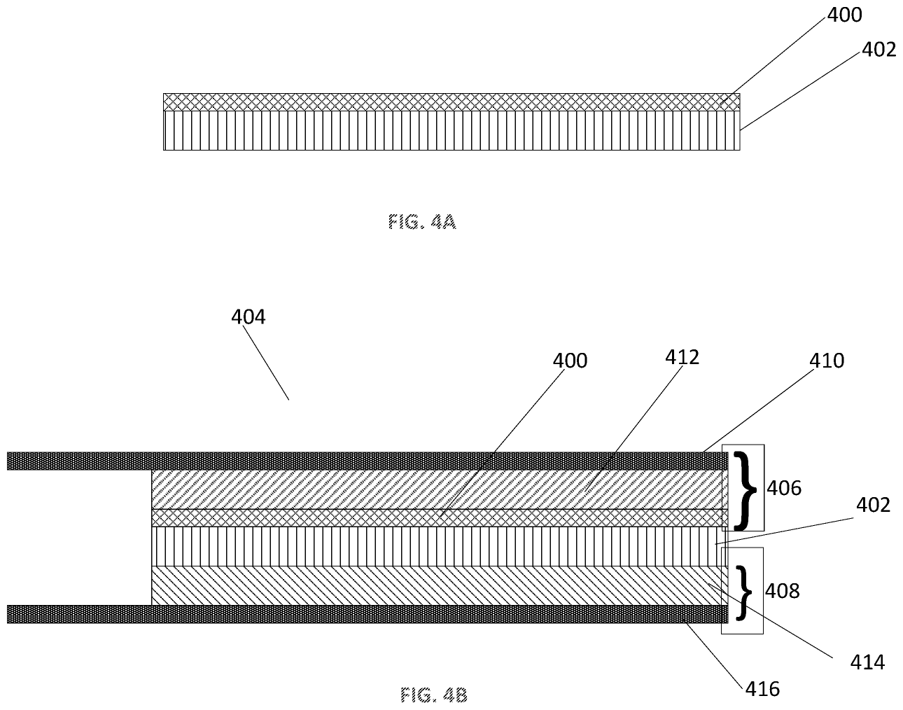

In another variation, a pre-lithiation layer is disposed on the separator. FIG. 4A depicts a side view of pre-lithiation layer 400 disposed on separator 402.

FIG. 4B depicts a side view of battery cell 404, including cathode 406, separator 402, and anode 408. The cathode 406 includes a cathode current collector 410 and a cathode active material layer 412 disposed on the cathode current collector 410. The pre-lithiation layer 400 is disposed on the separator 402. Anode 408 includes anode active material layer 414 and anode current collector 416.

Separator 402 can be as described in any other variation disclosed herein. Likewise, pre-lithiation layer 402 and components thereof can be as described in any other variation disclosed herein. Pre-lithiation layer 400 includes a lithium-containing fluoride or oxyfluoride, a metal fluoride and/or metal oxyfluoride, a binder, and a conductive material. The lithium-containing fluoride or oxyfluoride reacts with the metal fluorides and/or metal oxyfluorides to release Li ions in the system. Lithium ions are released from the reaction lithiate the battery cell.

### C. Modified Cathode Active Material Layer

In a further variation, a lithium-containing fluoride or oxyfluoride and metal fluoride/metal oxyfluoride can be mixed into the cathode active material layer.

Referring again to FIG. 2, a lithium-containing fluoride or oxyfluoride and metals/metal oxyfluoride are mixed in cathode active material layer 206. As in other variations, a lithium-containing fluoride or oxyfluoride reacts with the metal fluorides and/or metal oxyfluorides to release Li ions in the system. Lithium ions released from the reaction lithiate the battery cell.

The cathode current collector, cathode active material, separator, anode active material, and anode may be as described herein in any other variation.

In some variations, up to 20 wt % extra Li in the form of a lithium-containing fluoride or oxyfluoride is added to the system.

In some variations, at least 0.5 wt % Li of the stoichiometric amount of Li is added in the form of a lithium-containing fluoride or oxyfluoride to the cathode active material layer. In some variations, at least 1 wt % Li of the stoichiometric amount of Li is added in the form of a lithium-containing fluoride or oxyfluoride to the cathode active material layer. In some variations, at least 2 wt % Li of the stoichiometric amount of Li is added in the form of a lithium-containing fluoride or oxyfluoride to the cathode active material layer. In some variations, at least 3 wt % Li of the stoichiometric amount of Li is added in the form of a lithium-containing fluoride or oxyfluoride to the cathode active material layer. In some variations, at least 4 wt % Li of the stoichiometric amount of Li is added in the form of a lithium-containing fluoride or oxyfluoride to the cathode active material layer. In some variations, at least 5 wt % Li of the stoichiometric amount of Li is added in the form of a lithium-containing fluoride or oxyfluoride to the cathode active material layer. In some variations, at least 6 wt % Li of the stoichiometric amount of Li is added in the form of a lithium-containing fluoride or oxyfluoride to the cathode active material layer. In some variations, at least 7 wt % Li of the stoichiometric amount of Li is added in the form of a lithium-containing fluoride or oxyfluoride to the cathode active material layer. In some variations, at least 8 wt % Li of the stoichiometric amount of Li is added in the form of a lithium-containing fluoride or oxyfluoride to the cathode active material layer. In some variations, at least 9 wt % Li of the stoichiometric amount of Li is added in the form of a lithium-containing fluoride or oxyfluoride to the cathode active material layer. In some variations, at least 10 wt % Li of the stoichiometric amount of Li is added in the form of a lithium-containing fluoride or oxyfluoride to the cathode active material layer. In some variations, at least 11 wt % Li of the stoichiometric amount of Li is added in the form of a lithium-containing fluoride or oxyfluoride to the cathode active material layer. In some variations, at least 12 wt % Li of the stoichiometric amount of Li is added in the form of a lithium-containing fluoride or oxyfluoride to the cathode active material layer. In some variations, at least 13 wt % Li of the stoichiometric amount of Li is added in the form of a lithium-containing fluoride or oxyfluoride to the cathode active material layer. In some variations, at least 14 wt % Li of the stoichiometric amount of Li is added in the form of a lithium-containing fluoride or oxyfluoride to the cathode active material layer. In some variations, at least 15 wt % Li of the stoichiometric amount of Li is added in the form of a lithium-containing fluoride or oxyfluoride to the cathode active material layer. In some variations, at least 16 wt % Li of the stoichiometric amount of Li is added in the form of a lithium-containing fluoride or oxyfluoride to the cathode active material layer. In some variations, at least 17 wt % Li of the stoichiometric amount of Li is added in the form of a lithium-containing fluoride or oxyfluoride to the cathode active material layer. In some variations, at least 18 wt % Li of the stoichiometric amount of Li is added in the form of a lithium-containing fluoride or oxyfluoride to the cathode active material layer. In some variations, at least 19 wt % Li of the stoichiometric amount of Li is added in the form of a lithium-containing fluoride or oxyfluoride to the cathode active material layer.

In some variations, less than or equal to 20 wt % Li of the stoichiometric amount of Li is added in the form of a lithium-containing fluoride or oxyfluoride to the cathode active material layer. In some variations, less than or equal to 19 wt % Li of the stoichiometric amount of Li is added in the form of a lithium-containing fluoride or oxyfluoride to the cathode active material layer. In some variations, less than or equal to 18 wt % Li of the stoichiometric amount of Li is added in the form of a lithium-containing fluoride or oxyfluoride to the cathode active material layer. In some variations, less than or equal to 17 wt % Li of the stoichiometric amount of Li is added in the form of a lithium-containing fluoride or oxyfluoride to the cathode active material layer. In some variations, less than or equal to 16 wt % Li of the stoichiometric amount of Li is added in the form of a lithium-containing fluoride or oxyfluoride to the cathode active material layer. In some variations, less than or equal to 15 wt % Li of the stoichiometric amount of Li is added in the form of a lithium-containing fluoride or oxyfluoride to the cathode active material layer. In some variations, less than or equal to 14 wt % Li of the stoichiometric amount of Li is added in the form of a lithium-containing fluoride or oxyfluoride to the cathode active material layer. In some variations, less than or equal to 13 wt % Li of the stoichiometric amount of Li is added in the form of a lithium-containing fluoride or oxyfluoride to the cathode active material layer. In some variations, less than or equal to 12 wt % Li of the stoichiometric amount of Li is added in the form of a lithium-containing fluoride or oxyfluoride to the cathode active material layer. In some variations, less than or equal to 11 wt % Li of the stoichiometric amount of Li is added in the form of a lithium-containing fluoride or oxyfluoride to the cathode active material layer. In some variations, less than or equal to 10 wt % Li of the stoichiometric amount of Li is added in the form of a lithium-containing fluoride or oxyfluoride to the cathode active material layer. In some variations, less than or equal to 9 wt % Li of the stoichiometric amount of Li is added in the form of a lithium-containing fluoride or oxyfluoride to the cathode active material layer. In some variations, less than or equal to 8 wt % Li of the stoichiometric amount of Li is added in the form of a lithium-containing fluoride or oxyfluoride to the cathode active material layer. In some variations, less than or equal to 7 wt % Li of the stoichiometric amount of Li is added in the form of a lithium-containing fluoride or oxyfluoride to the cathode active material layer. In some variations, less than or equal to 6 wt % Li of the stoichiometric amount of Li is added in the form of a lithium-containing fluoride or oxyfluoride to the cathode active material layer. In some variations, less than or equal to 5 wt % Li of the stoichiometric amount of Li is added in the form of a lithium-containing fluoride or oxyfluoride to the cathode active material layer. In some variations, less than or equal to 4 wt % Li of the stoichiometric amount of Li is added in the form of a lithium-containing fluoride or oxyfluoride to the cathode active material layer. In some variations, less than or equal to 3 wt % Li of the stoichiometric amount of Li is added in the form of a lithium-containing fluoride or oxyfluoride to the cathode active material layer. In some variations, less than or equal to 2 wt % Li of the stoichiometric amount of Li is added in the form of a lithium-containing fluoride or oxyfluoride to the cathode active material layer.

Likewise, the metal/metal oxyfluoride can be added to cathode active material layer in any variation as described herein.

### D. Modified Cathode Active Material Particles

In some variations, the a lithium-containing fluoride or oxyfluoride and metal fluoride/metal oxyfluoride can be added to cathode active material particles.

In certain variations, less a lithium-containing fluoride or oxyfluoride can be added to the a lithium-containing fluoride or oxyfluoride to the cathode active material particles not to interrupt the crystal structure of the cathode active material particles.

In some variations, up to 2 wt % extra Li in the form of a lithium-containing fluoride or oxyfluoride is added to the system.

In some variations, at least 0.1 wt % Li of the stoichiometric amount of Li is added in the form of a lithium-containing fluoride or oxyfluoride to the cathode active material particles. In some variations, at least 0.2 wt % Li of the stoichiometric amount of Li is added in the form of a lithium-containing fluoride or oxyfluoride to the cathode active material particles. In some variations, at least 0.5 wt % Li of the stoichiometric amount of Li is added in the form of a lithium-containing fluoride or oxyfluoride to the cathode active material particles. In some variations, at least 0.75 wt % Li of the stoichiometric amount of Li is added in the form of a lithium-containing fluoride or oxyfluoride to the cathode active material particles. In some variations, at least 1.0 wt % Li of the stoichiometric amount of Li is added in the form of a lithium-containing fluoride or oxyfluoride to the cathode active material particles. In some variations, at least 1.25 wt % Li of the stoichiometric amount of Li is added in the form of a lithium-containing fluoride or oxyfluoride to the cathode active material particles. In some variations, at least 1.5 wt % Li of the stoichiometric amount of Li is added in the form of a lithium-containing fluoride or oxyfluoride to the cathode active material particles. In some variations, at least 1.75 wt % Li of the stoichiometric amount of Li is added in the form of a lithium-containing fluoride or oxyfluoride to the cathode active material particles.

In some variations, less than or equal to 2 wt % Li of the stoichiometric amount of Li is added in the form of a lithium-containing fluoride or oxyfluoride to the cathode active material particles. In some variations, less than or equal to 1.75 wt % Li of the stoichiometric amount of Li is added in the form of a lithium-containing fluoride or oxyfluoride to the cathode active material particles. In some variations, less than or equal to 1.50 wt % Li of the stoichiometric amount of Li is added in the form of a lithium-containing fluoride or oxyfluoride to the cathode active material particles. In some variations, less than or equal to 1.25 wt % Li of the stoichiometric amount of Li is added in the form of a lithium-containing fluoride or oxyfluoride to the cathode active material particles. In some variations, less than or equal to 1.0 wt % Li of the stoichiometric amount of Li is added in the form of a lithium-containing fluoride or oxyfluoride to the cathode active material particles. In some variations, less than or equal to 0.75 wt % Li of the stoichiometric amount of Li is added in the form of a lithium-containing fluoride or oxyfluoride to the cathode active material particles. In some variations, less than or equal to 0.50 wt % Li of the stoichiometric amount of Li is added in the form of a lithium-containing fluoride or oxyfluoride to the cathode active material particles. In some variations, less than or equal to 0.25 wt % Li of the stoichiometric amount of Li is added in the form of a lithium-containing fluoride or oxyfluoride to the cathode active material particles.

Cathode pre-lithiation can be used to compensate the lithium loss. Different oxide type pre-lithiation materials can be used in this process. Examples for cathode pre-lithiation materials include LisFeO₄, Li₆CoO₄, Li₂NiO₂ etc.

The battery cells described herein can be used in consumer products, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A cathode comprising:
a cathode current collector;
a cathode active material layer disposed on the cathode current collector; and
a pre-lithiation layer disposed on the cathode active material layer, the pre-lithiation layer comprising a lithium-containing fluoride or oxyfluoride, a metal fluoride and/or metal oxyfluoride, a first binder, and a conductive material.

2. The cathode of claim 1, wherein the first binder is polyvinylidene difluoride (PVDF).

3. The cathode of claim 1, wherein the metal fluoride and/or metal oxyfluoride is selected from FeF₃, CuF₂, CoF₂, FeFO, CuFO, and LiF.

4. The cathode of claim 1, wherein the cathode active material layer comprises a cathode active material, a second binder, and a conductive material.

5. The cathode of claim 4, wherein the conductive material is selected from carbon black and graphite.

6. The cathode of claim 4, wherein the second binder is polyvinylidene difluoride (PVDF).

7. A battery cell comprising:
the cathode of claim 1;
an anode comprising an anode active material disposed on an anode current collector, the anode oriented towards the cathode such that the anode active material faces the pre-lithiation layer; and
a separator disposed between the cathode and the anode,
wherein the pre-lithiation layer of the cathode is oriented toward the anode.

8. A set of layers comprising:
a separator; and
a pre-lithiation layer disposed on the separator, the pre-lithiation layer comprising a lithium-containing fluoride or oxyfluoride, a metal fluoride and/or metal oxyfluoride, a first binder, and a conductive material.

9. The set of layers of claim 8, wherein the first binder is polyvinylidene difluoride (PVDF).

10. The set of layers of claim 8, wherein the metal fluoride and/or metal oxyfluoride is selected from FeF₃, CuF₂, CoF₂, FeFO, CuFO, and LiF.

11. The set of layers of claim 8, wherein the conductive material is selected from carbon black and graphite.

12. A battery cell comprising:
a cathode comprising a cathode current collector and a cathode active material layer disposed on the cathode current collector;
the set of layers of claim 8, wherein the pre-lithiation layer is disposed on the separator facing the cathode; and
an anode comprising an anode active material disposed on an anode current collector, the anode oriented towards the cathode active material.

13. A cathode comprising:
a cathode current collector and a cathode active material layer disposed on the cathode current collector;
wherein the cathode active material layer comprises a cathode active material, a lithium-containing fluoride or oxyfluoride, a metal fluoride and/or metal oxyfluoride, a binder, and a conductive material.

14. The cathode of claim 13, wherein the binder is polyvinylidene difluoride (PVDF).

15. The cathode of claim 13, wherein the metal fluoride and/or metal oxyfluoride is selected from FeF₃, CuF₂, CoF₂, FeFO, CuFO, and LiF.

16. The cathode of claim 13, wherein the conductive material is selected from carbon black and graphite.

17. A battery cell comprising:
The cathode of claim 13;
an anode comprising an anode active material disposed on an anode current collector, the anode oriented towards the cathode such that the anode active material faces the cathode active material; and
a separator disposed between the cathode and the anode.

18. A cathode comprising:
a cathode current collector and a cathode active material layer disposed on the cathode current collector;
the cathode active material layer comprising a plurality of cathode active material particles, a binder, and a conductive material;
wherein the plurality of cathode active material particles comprise cathode active material, a lithium-containing fluoride or oxyfluoride, and a metal fluoride and/or metal oxyfluoride.

19. The cathode of claim 18, wherein the binder is polyvinylidene difluoride (PVDF).

20. The cathode of claim 18, wherein the metal fluoride and/or metal oxyfluoride is selected from FeF₃, CuF₂, CoF₂, FeFO, CuFO, and LiF.

21. The cathode of claim 18, wherein the conductive material is selected from carbon black and graphite.

22. A battery cell comprising:
the cathode of claim 18;
an anode comprising an anode active material disposed on an anode current collector, the anode oriented towards the cathode such that the anode active material faces the cathode active material layer; and
a separator disposed between the cathode and the anode.
